(19) United States
(12) Patent Application Publication
(10) Pub. No.: US 2013/0321302 A1
(43) Pub. Date: Dec. 5, 2013

(54) DEVICE FOR KEYING IN DATA IN BRAILLE, CORRESPONDING METHOD AND COMPUTER PROGRAM PRODUCT

(71) Applicants: David Naccache, Paris (FR); Vincent Hernandez, Oytier-Saint-Oblas (FR); Guillaume Andre, Valence (FR); Thierry Marsaud, Talence (FR); Jean-Louis Olive, Valence (FR); Jean-Jacques Delorme, Saint-Marcel-Les-Valence (FR); Jean-Louis Sarradin, Etables (FR); Frederic Bern, Paris (FR)

(72) Inventors: David Naccache, Paris (FR); Vincent Hernandez, Oytier-Saint-Oblas (FR); Guillaume Andre, Valence (FR); Thierry Marsaud, Talence (FR); Jean-Louis Olive, Valence (FR); Jean-Jacques Delorme, Saint-Marcel-Les-Valence (FR); Jean-Louis Sarradin, Etables (FR); Frederic Bern, Paris (FR)

(73) Assignee: Compagnie Industrielle et Financiere D'Ingenierie "Ingenico", Paris (FR)

(21) Appl. No.: 13/878,068

(22) PCT Filed: Oct. 6, 2011
(86) PCT No.: PCT/EP11/67514

§ 371 Date: Jul. 22, 2013

(30) Foreign Application Priority Data
Oct. 7, 2010 (FR) 1058161

(51) Int. Cl. G06F 3/0488

(52) U.S. Cl. CPC G06F 3/0488
USPC 345/173

(57) ABSTRACT

A device is provided for logging data in Braille. The device includes a touch-sensitive surface and is configured to detect a plurality of pressures on the touch-sensitive surface, wherein the plurality of pressures form a Braille character, construct an image formed from the points associated with the plurality of pressures; and recognize the Braille character based on an analysis of the image.

### CROSS-REFERENCE TO RELATED APPLICATIONS

This Application is a Section 371 National Stage Application of International Application No. PCT/EP2011/067514, filed Oct. 6, 2011, which is incorporated by reference in its entirety and published as WO 2012/045844 on Apr. 12, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the invention is that of devices comprising a touch-sensitive surface, such as a touch-sensitive screen for example.

More specifically, the invention pertains to such devices and their improvement with a view to their use by a user having visual deficiency, for example a visually impaired or sightless user. Here below, such a user is designated by the expression “sightless user”.

In particular, the invention can be applied to electronic payment terminals comprising a touch-sensitive surface of this kind and to the keying in of data, especially digital data, such as a pin code (four digits and one “enter” key for example) or a similar identifier on the touch-sensitive surface of such terminals.

### BACKGROUND OF THE DISCLOSURE

At present, there is an increasing number of known devices comprising a touch-sensitive surface, such as mobile telephones, personal digital assistants (PDAs), laptops, automatic cash dispensers or again business cash registers.

There also exist electronic payment terminals comprising a touch-sensitive surface, for example a touch-sensitive screen. In this case, such a touch-sensitive screen depicts for example a virtual keyboard for validating a confidential code or the amount of a transaction.

One drawback of these electronic payment terminals however lies in the fact that they cannot be used by a sightless user in a simple and confidential manner. Indeed, unlike in electronic payment terminals comprising a screen and a keyboard in which the keys are in relief and certain keys have a tactile marker on their surface (in particular, the digit 5 and the “enter”, “correct” or “cancel” keys), each key of the virtual keyboard of an electronic payment terminal comprising a touch-sensitive screen can only be detected visually.

There also exist devices, such as graphics tablets or personal digital assistants (PDAs) comprising a touch-sensitive surface on which a user can plot curves to key in data on the touch-sensitive surface, for example alphanumerical data, the keyed-in data being then processed by a character recognition application. These devices, which make it possible to key in or “draw” data by means of a “continuous” line on the touch-sensitive surface, are not easy to use for a sightless user. In addition, in the case of electronic payment terminals, such keying-in operations do not comply with the security constraints laid down in the field of banking transactions. It would indeed be easy for a malicious observer to detect the digits being drawn on the touch-sensitive screen and then to reproduce them.

There is therefore a need for novel portable devices comprising a touch-sensitive screen or a touch-sensitive surface enabling them to be used by any user, including sightless users.

### SUMMARY

The invention proposes a novel solution to this problem in the form of a device for keying in data in Braille, the device comprising a touch-sensitive surface.

The device of the invention in one embodiment implements:
means for detecting a plurality of relative presses on the touch-sensitive surface, the plurality of relative presses being intended to form a Braille character;
means for building an image formed by dots associated with the plurality of relative presses, taking account of at least one predetermined criterion for adjusting the position of the dots corresponding to the relative presses detected;
means for recognizing the Braille character as a function of an analysis of the image.

A device of this kind makes it possible, for example for a user having visual deficiency, to key in data in Braille on a touch-sensitive surface, for example to key in a confidential code or an amount of a transaction when the device is an electronic payment terminal. Thus, a sightless user finds himself in a familiar Braille writing environment, and this makes such a device more ergonomical for him than a device providing a “classic” writing environment.

Furthermore, such a device is compatible with the high security requirements related to electronic payment terminals Indeed, a malicious individual observing a sightless person keying into the touch-sensitive surface in Braille, i.e. by successive or simultaneous presses representing the dots of the Braille characters, would find it difficult to recognize what this sightless person is keying in with the intention of reproducing it. For these are only dots or groups of dots struck with one or more fingers and not a line which can be observed from a distance.

In standard Braille, a character is represented in a matrix of six dots on two columns, each character being formed by one to six dots (in relief in the case of rendering on paper). These dots are conventionally numbered from top to bottom and from left to right. The term “Braille character” is understood here to mean especially a layout of this kind in the six-dot matrix, such as for example Braille characters defined in the corresponding alphabet (a character representing a letter or else a character representing a digit, a character indicating a digit, punctuation or other symbols) or characters specifically defined for a particular context and corresponding for example to a word, a sequence of words or again a symbol, etc. However, the invention can be applied to a slightly different format (number of dots considered, distribution of dots, etc) and/or another alphabet (a different characterization of the letters or digits on the matrix of dots).

For example, the means for detecting presses on the touch-sensitive surface of the device enable the detection of different keying-in operations (the plurality of presses) relative to each digit forming a confidential code.

The means for building the keying in device then make it possible to convert these presses into dots of an image using 2D coordinates of the detected presses so as to form an image corresponding to the plurality of presses detected on the touch-sensitive surface. In this way, a representation is obtained of the data keyed in by the user in the form of an image which is then analyzed so as to recognize or not recognize a Braille character. For example, the image obtained from the plurality of presses can be compared with a predetermined set of Braille characters.

It must be noted that only the relative position between the presses is necessary to build the image, regardless of the position of the presses on the touch-sensitive surface (centered or not, towards the top or towards the bottom). Again, this makes a remote detection of the keyed in data more complex.

According to one particular embodiment of the invention, the touch-sensitive surface is suited to the simultaneous keying in of at least two relative presses so that at least two constituent dots of the Braille character are keyed in simultaneously.

In this way, the complete keying in of a piece of data in Braille is quicker, it being possible to key in certain dots that form it simultaneously with simultaneous presses on the touch-sensitive surface.

In addition, according to this embodiment, the means for detecting can directly obtain the relative positions of the simultaneous presses. The detection of the keyed in data is therefore made more reliable, as also the building of the associated image.

Furthermore, this type of keying in further increases the difficulty of remote detection by a malicious person (it is indeed not easy to identify the position of two or three fingers applied simultaneously to know whether there has really been this number of presses or whether a finger is waiting in mid-air and to detect whether the presses correspond to a left-hand zone or right-hand zone of the matrix, its upper part or its lower part, etc).

According to another particular aspect of the invention, the means for detecting comprise means for measuring a period of time between two successive presses so that presses made within the period of time belong to the plurality of presses when the period of time measured is smaller than a predetermined reference period of time.

In this way, the user can enter several pieces of data in Braille successively in separating them by a period of time greater than that needed to key in different elements of a same piece of data (without needing a specific operation to validate the keying in of each piece of data).

Indeed, according to this embodiment, the means for detecting are capable of distinguishing successive presses according to the period of time between them, for example by comparing the period of time with a predetermined threshold. In this way, if a period of time greater than the threshold is measured between two successive presses, the means for detecting consider these successive presses as not belonging to a same plurality of presses and therefore the means for building an image consider the associated dots as not belonging to a same image. In this case, at least two pieces of Braille data are detected, for example two digits.

According to another embodiment of the invention, the means for recognizing are capable of recognizing at least one control command, i.e. a distinct piece of data of a Braille character.

For example, in the case of the keying in of a confidential code, this control command can correspond to a cancellation of the previous keying-in operation (“Cancel”), to a correction of the previous keying-in operation (“Correct”), or again to a validation of the previously performed keying-in operations (“Enter”). Furthermore, such a command can also correspond to a special Braille character used to indicate a numeral character. Such a command can also correspond to a predefined sign corresponding to the word “YES” or to the word “NO” if necessary.

Thus, for example, the device is capable of recognizing a complete keying in of a confidential code, including the final validation indicating that the user has terminated his keying-in operation, enabling a sightless user to be independent for the complete keying in of such a confidential code in Braille.

According to one particular aspect of the invention, at least one of the control commands corresponds to a movement on the touch-sensitive surface and the means for detecting are capable of detecting a movement on the touch-sensitive surface. Thus, the means for detecting are not only capable of detecting a plurality of successive presses, whether simultaneous or not, but are also capable of detecting a particular keying-in operation on the touch-sensitive surface, corresponding for example to a lengthy and mobile press on the surface. Thus, according to this embodiment, a piece of data to be keyed in can be defined otherwise than by a succession of presses, as in the case of a “classic” Braille character. For example, this keying-in operation can correspond to a horizontal or vertical movement on the touch-sensitive surface.

According to one embodiment of the invention, the means for building comprise means of vertical and/or horizontal alignment of dots keyed in at different instants. Thus, when certain dots corresponding to successive presses are not quite aligned, the means for building the image can realign them according to certain criteria. One such criterion corresponds for example to a maximum deviation beyond which the means for building the image consider it to be the case that the dots should not be aligned.

According to this embodiment, it is therefore possible to take account of a lack of precision of the keying-in operation due to the fact that the user does not have any marker available on the touch-sensitive surface and that his finger can deviate slightly between two successive presses, whereas he would like them to be aligned.

According to one particular aspect of the invention, the means for building comprise means for detecting and/or correcting a deviation between two dots.

Here again, according to this embodiment, certain deficiencies of precision in keying in can be corrected, as in the case for example of a non-compliant deviation between two dots. Thus, the means for building the image take account of the fact that the pieces of data keyed in by the user are chiefly Braille characters, i.e. sets of dots positioned in a matrix with two columns and three rows as already described. For example, when two dots are far too distant from one another even though they belong to a same representation of a Braille character, the means for building reduce the deviation between the two dots so that the image built can then be compared with the different possible Braille characters.

According to another aspect of the invention, the device furthermore comprises means for the secured rendering of the recognized Braille character in audio and/or tactile form.

Thus, the user can check whether his keying in operation is in conformity with his intention before validating it, thus preventing keying-in errors. This embodiment proves to be particularly advantageous when keying in a confidential code for which a limited number of errors is permitted.

According to this embodiment, when the safety standards permit it, the recognized Braille character can be rendered in a secured manner to the user in audio form, confidentially, for example through an earpiece connected to the device. The secured rendering can also be tactile, for example through a touchpad placed beneath the device and enabling the rendering of a Braille character, for example by means of a strip of small pins rising or descending in order to compose the characters.

The invention also pertains to a method for keying in data in Braille comprising a touch-sensitive surface.

According to the invention, such a method comprises the following steps:
detecting a plurality of relative presses on the touch-sensitive surface, the plurality of relative presses being intended to form a Braille character,
building an image formed by dots associated with the plurality of relative presses as a function of at least one predetermined criterion for adjusting a position of the dots corresponding to the relative presses detected;
recognizing the Braille character as a function of an analysis of the image.

Such a method can be implemented in a device for keying in as described here above.

Finally, the invention pertains to a computer program characterized in that it comprises program code instructions for implementing the method as described here above when this program is executed by a processor.

### BRIEF DESCRIPTION OF THE DRAWINGS

Other characteristics and advantages of the invention shall appear more clearly from the following description of a particular embodiment given by way of a simple illustratory and non-exhaustive example and from the appended drawings, of which:

FIG. 1 illustrates an example of a simplified structure of a keying-in device according to one embodiment of the invention;

FIGS. 2a and 2b respectively present an example of a keying-in device and the main pieces of data capable of being keyed in according to one embodiment of the invention pertaining to the keying in of a confidential code;

FIG. 3 illustrates the main keying-in steps in the embodiment of FIG. 2;

FIG. 4 illustrates the main steps of the method for keying in according to one embodiment of the invention.

### DETAILED DESCRIPTION OF ILLUSTRATIVE EMBODIMENTS

1. General Principle

The general principle of the invention relies on the detection of a plurality of presses on a touch-sensitive surface of a keying-in device enabling the recognition of a Braille character keyed-in by the user.

Thus, a sightless user, familiar with Braille writing, can key in data in Braille on a touch-sensitive screen for example to validate a bank transaction through the keying in of a confidential code.

According to the general principle of the invention, once the plurality of presses has been detected, the device builds an image formed by dots corresponding to the plurality of presses to obtain a representation of the piece of data keyed in by the user. This representation is then analyzed so as to recognize the Braille character or predefined command to which it corresponds.

2. Description of One Embodiment

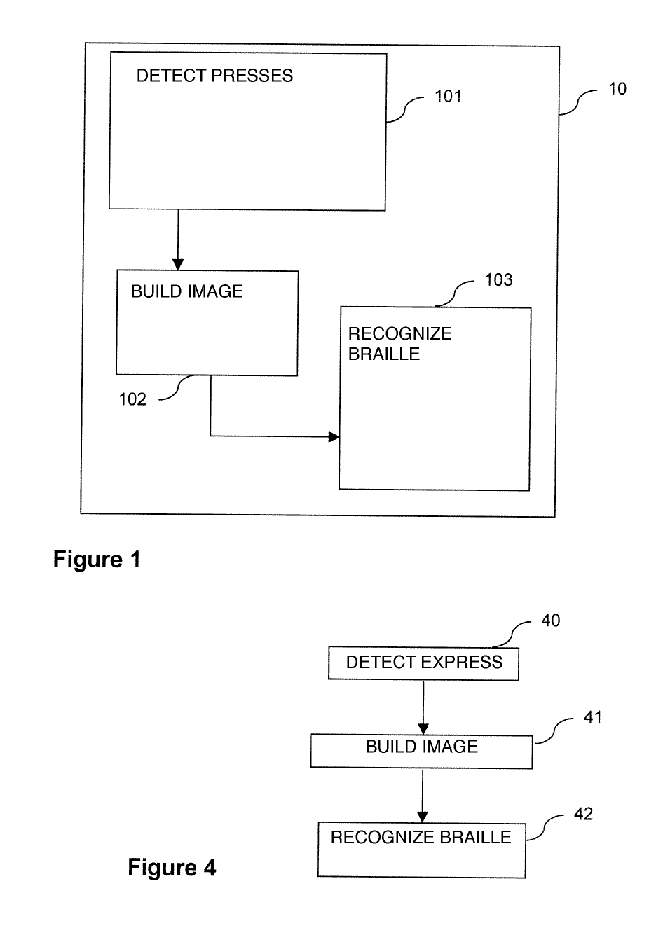

Referring to FIG. 1, an example is presented of a simplified structure of a keying-in device 10 according to one embodiment of the invention.

The keying-in device 10 comprises first of all means 101 for detecting a plurality of presses on the touch-sensitive surface, for example by means of a stylus or else a finger of the user, this plurality of presses being intended to form a Braille character as defined here above, i.e. a known character of the Braille alphabet or else a character defined specifically to represent a word, a symbol, etc.

The means 101 for detecting according to this embodiment detect the coordinates of the presses on the touch-sensitive surface so as to then transmit them to the means for building an image representing the piece of data keyed in by the user.

For greater efficiency and precision of detection, the means 101 for detecting comprise especially means for measuring a period of time between two successive presses.

In this way, presses performed in a period of time smaller than a predetermined reference period of time are considered to belong to the plurality of presses and are therefore intended to form a Braille character. By contrast, two successive presses separated by a period of time greater than a predetermined reference period of time are considered to belong to two successive pluralities of presses.

According to one alternative of this embodiment, the touch-sensitive surface of the keying-in device also is suited to the simultaneous keying in of at least two presses so that at least two constituent dots of the Braille character can be keyed in simultaneously. The means 101 for detecting are therefore also capable of detecting at least two simultaneous presses.

This variant makes it possible especially for the user to carry out a faster keying-in operation.

Besides, this variant reinforces the security of a keying-in device used to key in a confidential code for example, since it is even more difficult to identify at least two simultaneous presses on a touch-sensitive surface to deduce from them the Braille character being keyed in.

According to another alternative embodiment, the means for detecting are capable of detecting a movement on the touch-sensitive screen instead of a brief press classically used to key in a dot of a Braille character. For example, a movement of this kind can correspond to a lengthy and mobile press which may be horizontal or vertical on the touch-sensitive surface.

In particular, such keying-in operations correspond to a movement used to define control commands such as for example the validation of a keying-in operation or again a “yes” or “no” response. Such keying-in operations actually make it possible to define a command, or an action, with a single specific Braille character.

Once the plurality of presses has been detected by the means 101 for detecting, it is processed by means 102 for building an image which associate a dot on an image with a detected press, through the coordinates of the pressure movement so as to obtain a 2D representation of the presses performed by the user.

Besides, since the goal of the invention is to recognize a Braille character keyed in by a user, i.e. chiefly a set of dots contained in a matrix of six dots on two columns, the means 102 for building an image may include means for adjusting the location of the dots corresponding to the presses detected in order to take account of the lack of precision of position in the keying-in operation.

In particular, according to one alternative embodiment, the means 102 for building an image comprise means of vertical and/or horizontal alignment of dots keyed in at different points in time.

Thus, the image is built according to a matrix with six predefined locations and if the coordinates of certain detected presses do not correspond precisely to these locations, the means of alignment make it possible to position the dots by modifying their coordinates according to predetermined criteria. For example, a predetermined criterion corresponds to a maximum deviation between the coordinates of a detected press and the position of a dot of the matrix. Beyond this deviation, the means of alignment are not applied.

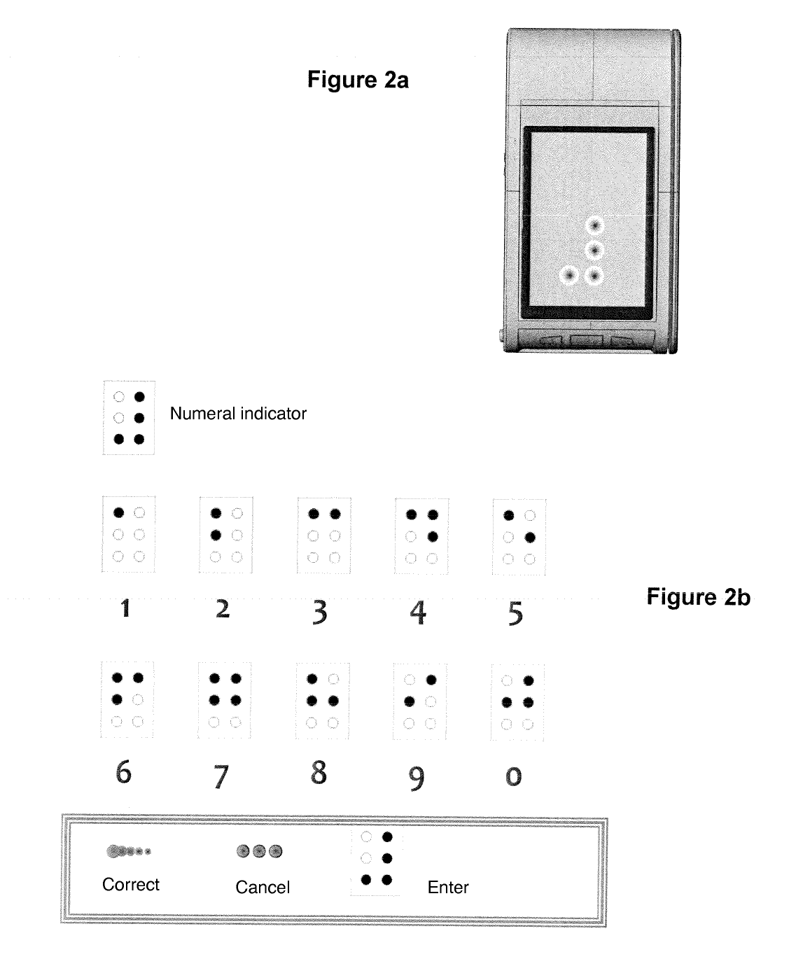

If a control command is detected by the means for detecting, in the form of a shifting on the touch-sensitive surface, the means for building the image represent for example the shifting by a succession of aligned dots of decreasing sizes, as described here below with reference to FIG. 2b.

Once the image has been built, it is analyzed by means 103 for recognizing Braille characters. For example, the means for recognizing compare the image with a predetermined set of Braille characters and deliver a recognition decision.

This decision can be negative if the image does not correspond to any Braille character of the set.

In the case of a positive comparison, the means for recognizing deliver for example the alphanumeric value of the recognized Braille character or again the symbol represented by the recognized Braille character.

FIG. 4 illustrates the main steps of the method for keying in according to this embodiment, capable of being implemented in a keying-in device as described here above.

The first step 40 for detecting presses consists in detecting the coordinates of the presses on the touch-sensitive surface which are then processed during a step 41 for building an image representing the piece of data keyed in by the user.

Once this image has been built, a step 42 for recognizing a Braille character is implemented, delivering a positive recognition result, for example the recognized Braille character, or a negative recognition result.

3. Description of an Example of an Application of the Invention

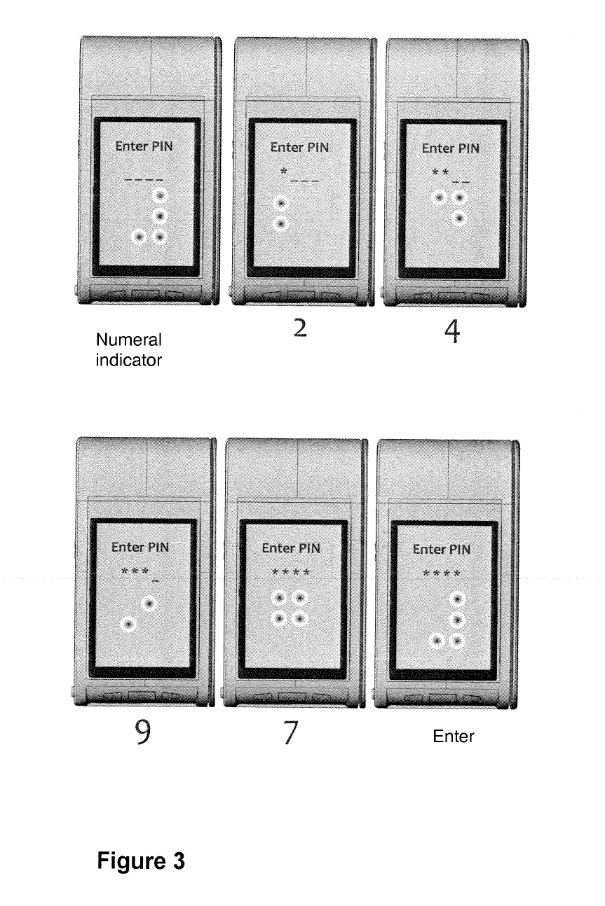

Referring now to FIGS. 2a, 2b and 3, an example is presented of an application of the invention in an electronic payment terminal having a touch-sensitive surface enabling the keying in of a four-digit confidential code in Braille.

It must be noted that the Braille characters represented in this example of an application belong to the Braille alphabet in English by way of an illustratory and non-exhaustive example. The use of Braille characters in any other alphabet is obviously possible according to the invention.

FIG. 2a represents a terminal of this kind in which a Braille character has been entered by a user.

FIG. 2b for its part presents the different Braille characters recognizable in the context of such an application, i.e. especially the numeral characters representing the digits 1 to 9 as well as the special numeral indicator character classically keyed in before a numeral character as well as Braille characters representing commands such as the command for correcting the previous keying-in operation, the command for cancelling the previous keying-in operation and the “enter” command (which besides is identical to the special numeral indicating character).

Thus, as illustrated in FIG. 3, in this context of keying in a confidential four-digit code, the user must first of all key in the numeral indicator character and then the four digits of his confidential code (2497 in the example of FIG. 3) and finally the “enter” character.

It may be recalled that according to one particular embodiment of the invention, the user can key in several simultaneous presses on the touch-sensitive surface.

Furthermore, the keying in of the first special numeral indicating character can also enable the defining of the orientation of the touch-sensitive surface, namely in portrait or landscape mode, so as to facilitate the detection of subsequent presses.

When the user starts keying in the Braille characters listed here above, the means for detecting detect the different corresponding presses.

As described here above, the means for detecting can implement means for measuring a period of time between two successive presses so that it is possible, through a reference period of time, to determine whether two successive presses constitute a single Braille character or belong to two successive distinct Braille characters.

For example, when the user keys in the first numeral indicating character, it is probable that he does so in at least two stages, a first stage to simultaneously key in the two vertical dots at the top right-hand of the character, and a second stage to simultaneously key in the two horizontal dots at the bottom of the character. The means for detecting must consider these two stages to be close enough to each other for the presses performed in these two stages to be considered as constituting a single Braille character.

Besides, the user must comply with a lengthier time interval before starting to key in the first figure (2), so that the means for detecting detect the end of the keying in of one character and the start of the keying in of a following character.

When the means for detecting detect the end of the keying in of a character, the pieces of data corresponding to this keying in are transmitted to the means for building an image. These pieces of data are for example the coordinates corresponding to the different presses performed by the user, for example four presses for the numeral indicating character.

These coordinates are then processed by the means for building an image so as to obtain a 2D representation of the dots corresponding to the presses keyed in by the user.

As already indicated here above, the means for building an image can implement means for adjusting coordinates of the presses keyed in, for example by aligning presses vertically and/or horizontally, as a function of predetermined criteria.

Similarly, the means for building an image can also implement means for detecting and/or correcting a deviation between two dots as a function of predetermined criteria so as to make it possible to obtain an image potentially corresponding to a Braille character, i.e. dots laid out in a matrix of three rows and two columns. For example, these means for correcting a deviation between two dots are implemented only when the deviation detected is smaller than a threshold.

Once the image has been built, it is analyzed by the means for recognizing Braille characters so as to know which character has been keyed in by the user.

It is recalled that the means for recognizing are capable of recognizing not only a prior-art Braille character coming from a Braille alphabet but also control commands represented by specific Braille characters such as for example a particular layout of dots in the classic matrix of six dots on three rows in two columns (“enter” command illustrated in FIG. 2b) or a succession of horizontal or vertical dots (“cancel” command illustrated in FIG. 2b) or again a representation of a shift detected on the touch-sensitive surface (“correct” command illustrated in FIG. 2b).

The analysis of the image consists for example in comparing this image with a set of representations of reference Braille characters such as those represented in FIGS. 2b.

After analysis, the means for recognizing deliver a positive or negative result of recognition.

The result is negative when, according to the means for recognizing, the image does not correspond to a Braille character.

The result is positive when the image corresponds to a Braille character and, in this case, the means for recognizing deliver for example the recognized character in the corresponding alphanumerical form, or the title of the recognized control command.

For example, when the recognized Braille character corresponds to the digit 2, it is this digit that is delivered.

When the “Enter” command is recognized, then the means for recognizing deliver an indication that the keying in has ended, making it possible, in the context of the application described, to implement the classic application for validating the confidential code keyed in by the user.

According to one variant of this example of an application, the keying in device also comprises means of secured rendering of the recognized Braille character in audio form and/or tactile form so as to interact with the user. Thus, the user can confirm or negate a keying in operation before performing the next keying in operation.

This variant is advantageous for the use of the electronic payment terminal by a sightless user who is not capable of visually verifying the validity of his keying-in operation and especially when the keying-in operation corresponds to a confidential code. Indeed, this makes it possible for such a user not to be penalized by the security rules laid down in this field of application where, especially, only three successive attempts are allowed for keying in a confidential code.

If the user has secured means available for verifying each piece of Braille data keyed in, he runs a smaller risk of keying in errors and hence a smaller risk of rejection of the keying in of his confidential code.

Besides, according to yet another variant of the invention, the keying in device may comprise “classic” keys outside the touch-sensitive surface for the control commands such as “Enter”, “Correct”, or “Cancel”. This variant makes the keying in of a confidential code faster and more precise, since the classic keys are marked as in a classic electronic payment terminal and can therefore be recognized by a sightless user through touch.

An embodiment of the invention therefore provides a device with a touch-sensitive surface that can be used by any user, including a sightless user.

An embodiment of the invention provides a device of this kind that is also ergonomical and intuitive for the user, whether sighted or sightless.

An embodiment of the invention provides a low-cost and easy-to-manufacture device of this kind.

An embodiment of the invention provides a device of this kind that complies with the requirements of security and confidentiality prevailing in the field of application of the device. In particular, an embodiment of the invention provides a technique which prevents or at least makes it difficult for a malicious individual to read the data introduced into a touch-sensitive surface.

Although the present disclosure has been described with reference to one or more examples, workers skilled in the art will recognize that changes may be made in form and detail without departing from the scope of the disclosure and/or the appended claims.

1. A device for keying in data in Braille, comprising:
a touch-sensitive surface;
means for detecting a plurality of relative presses on said touch-sensitive surface, said plurality of presses being intended to form a Braille character;
means for building an image formed by dots associated with said plurality of presses, the means for building taking account of a relative position of the presses; and
means for recognizing said Braille character as a function of an analysis of said image.

2. The device for keying in data in Braille according to claim 1, wherein said touch-sensitive surface is suited to simultaneous keying in of at least two presses, so as to key in simultaneously at least two constituent dots of the Braille character.

3. The device for keying in data in Braille according to claim 1, wherein said means for detecting comprise means for measuring a period of time between two successive presses so that presses made within said measured period of time belong to said plurality of presses when said period of time is smaller than a predetermined reference period of time.

4. The device for keying in data in Braille according to claim 1, wherein said means for recognizing are capable of recognizing at least one control command.

5. The device for keying in data in Braille according to claim 4, wherein at least one of said control commands corresponds to a movement on said touch-sensitive surface and said means for detecting are configured to detect said movement on said touch-sensitive surface.

6. The device for keying in data in Braille according to claim 1, wherein said means for building comprise means of vertical and/or horizontal alignment of the dots keyed in at different instants.

7. The device for keying in data in Braille according to claim 1, wherein said means for building comprise means for detecting and/or correcting a deviation between two dots.

8. The device for keying in data in Braille according to claim 1, wherein the device furthermore comprises means for the secured rendering of the recognized Braille character in audio and/or tactile form.

9. A method for keying in data in Braille comprising a touch-sensitive surface, wherein the method comprises the following steps:
detecting a plurality of presses on said touch-sensitive surface, said plurality of presses being intended to form a Braille character,
building an image formed by dots associated with said plurality of presses, the building of the image being a function of a relative position of the presses; and
recognizing said Braille character as a function of an analysis of said image.

10. A Computer program comprising program code instructions for implementing a method of keying in data in Braille using a touch-sensitive surface when said program is executed by a processor, wherein the method comprises the following steps:
instructions that configure the processor to detect a plurality of presses on said touch-sensitive surface, said plurality of presses being intended to form a Braille character,
instructions that configure the processor to build an image formed by dots associated with said plurality of presses, the building of the image being a function of a relative position of the presses; and
instructions that configure the processor to recognize said Braille character as a function of an analysis of said image.
